(19) United States
(12) Patent Application Publication
(10) Pub. No.: US 2003/0080548 A1
(43) Pub. Date: May 1, 2003

(54) Multi-panel lottery ticket

(76) Inventors: Joseph Carl Borowski JR., San Antonio, TX (US); Carla Schaefer, San Antonio, TX (US)

Correspondence Address: WATOV & KIPNES, P.C., P.O. Box 247, Princeton Junction, NJ, 08550, US

(21) Appl. No.: 10/262,788

(22) Filed: Oct. 2, 2002

Related U.S. Application Data
(60) Provisional application No. 60/328,659, filed on Oct. 11, 2001.

(51) Int. Cl. G09B 19/00

(52) U.S. Cl. 283/49

(57) ABSTRACT

A lottery ticket having multiple panels which can be folded upon or in proximity to each other to form a unique visual display in which multiple lottery game areas can be provided on one or more of the panels to play one or more separate lottery games or one or more interactive games.

### FIELD OF THE INVENTION

The present invention is directed to a lottery ticket comprised of multiple panels which may be folded one upon the other. Each of the panels may contain printing graphics, one or more interactive lottery games and/or a separate lottery game. When the panels are folded upon each other and the lottery ticket is in the folded condition, the front of the lottery ticket presents a unique three dimensional graphic display which results from the combination and complimentary relationship of at least two of the folded panels. The front and/or rear faces of each of the panels may include a lottery game, a prize designation area and/or a graphic display. The lottery tickets of the present invention provide a dynamic three dimensional graphic display while enabling the player to partake in one or more lottery interactive and/or separate games.

### BACKGROUND OF THE INVENTION

Scratch-off lottery tickets are common in the lottery industry. Game data is covered by a scratch-off layer and when the scratch-off layer is removed, the game data is exposed. Once the scratch-off layer is removed, if the game symbols provide a certain pattern (e.g. three of the same symbol) the player may win a prize. Thus, the typical scratch-off lottery tickets require the player to remove the scratch-off layer and immediately determine what prize has been won.

Typical lottery tickets of this type are printed on a single surface or substrate with printing graphics that describe the theme of the game (e.g. Bingo) and may provide a prize designation area as well as instructions for playing the game and how to redeem a winning ticket.

Both sides of the single panel lottery ticket typically have printing thereon. It is most common for the rear surface of the single panel to contain instructions for playing the game and instructions for redeeming the ticket for a prize.

The lottery game itself is typically played in a game area. This game area as well as a prize designation area, and graphics related to the theme of the game are typically printed on the front surface of the lottery ticket. Some lottery tickets have been made with multiple game areas, each of which may have a prize designation area which provides information to the player of whether the lottery ticket is a prize winning ticket and the type of prize that may have been won. Such tickets typically have game areas separate from each (i.e. each game area is played independently from each other game area), which are printed on the front face of the ticket.

It is desirable in the scratch-off lottery industry to provide lottery tickets which not only provide the opportunity to win a prize but also provide unique visual display and/or playing benefits which are attractive to lottery players.

It would therefore be a significant advance in the scratch-off lottery ticket industry to provide a lottery ticket which is capable of providing multiple games including interactive games and a unique graphic display which the lottery player will find intriguing.

### SUMMARY OF THE INVENTION

The present invention is generally directed to a lottery ticket comprised of at least two panels which are foldable upon or in proximity to each other to provide a unique graphic display which in a preferred form of the invention conveys a unique three dimensional appearance. The present lottery ticket is also capable of providing multiple game areas by including one or more games on up to all of the separate panels. The game areas may include separate games and/or interactive games as hereinafter defined.

In a particular aspect of the present invention, there is provided a lottery ticket comprising a plurality of panels each having a front face exhibiting an incomplete visual display and a rear face and being foldable upon or in proximity to each other, at least two of the faces being positioned over or in proximity to each other and together forming a collective face of the lottery ticket which forms the unique, complete visual display which may include a graphic display by the combination of the incomplete visual displays.

In a preferred form of the invention, the lottery ticket has at least two game areas and in a further preferred embodiment of the invention, the lottery ticket is comprised of four panels each having front and rear faces which when placed over or in proximity to each other form a three dimensional visual display which may include a graphic printed design. Such lottery tickets can include game areas including separate games and/or interactive games on any one or more of the front and rear faces of one or more of the panels.

### BRIEF DESCRIPTION OF THE DRAWINGS

The following drawings in which like reference characters indicate like parts are illustrative embodiments of the invention and are not intended to limit the invention as disclosed in the application.

FIG. 1 is a front view of a two panel lottery ticket with the front faces thereof exposed;

FIG. 2 is a front view of the lottery ticket of FIG. 1 in the folded condition with the two panels folded one upon the other;

FIG. 3 is a rear view of another embodiment of the invention in which the lottery ticket is composed of four panels;

FIG. 4 is a front view of the lottery ticket shown in FIG. 3 in the unfolded position;

FIG. 5 is a front view of the lottery tickets shown in FIGS. 3 and 4 in the folded condition with the panels folded upon each other;

FIG. 6 is a front view of a further embodiment of the invention in which the lottery ticket is composed of four panels with four interactive game areas; and

FIG. 7 is a front view of a further embodiment of the invention in which the top and bottom panel portions are folded in proximity to each other.

### DETAILED DESCRIPTION OF THE INVENTION

As used herein the term “separate lottery game” shall mean a lottery game that is played within a single game area. The term “interactive lottery game” shall mean a lottery game that is played within at least two game areas. The term “folded upon each other” shall mean that at least a portion of at least one panel is placed on top of another panel. The term “in proximity to each other” shall mean that at least two panels are adjacent each other along a common border to form a collective visual display. The term “visual display” shall mean a design formed by the complimentary panels which may include a graphic display such as a printing design.

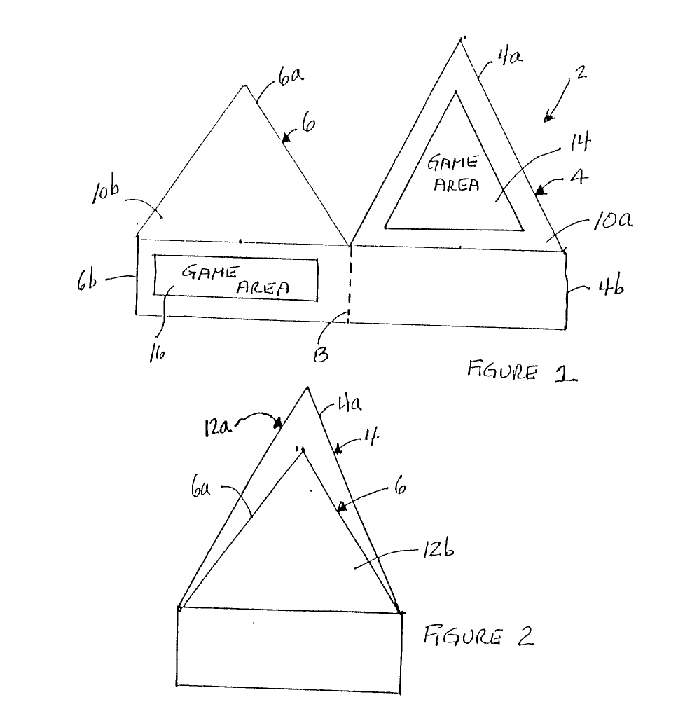

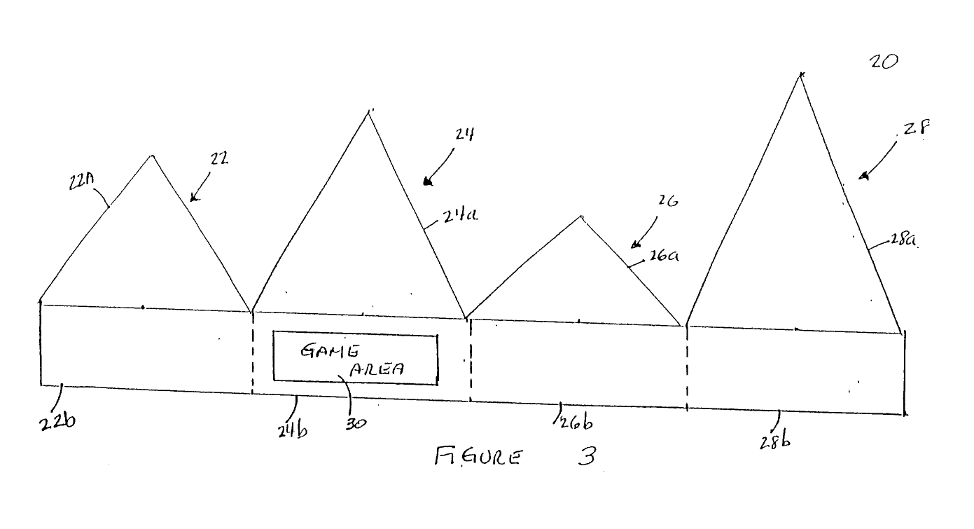

Referring to FIGS. 1 and 2, there is shown an embodiment of the lottery ticket of the present invention comprising two panels. In particular, there is shown a lottery ticket 2 having respective panels 4 and 6 attached at a common fold line 8. In accordance with this embodiment of the present invention, the panels 4 and 6 are foldable upon each other. The size of the panels 4 and 6 are not identical so that when the panels are in the folded condition a portion of both panels are visible to the player. The exposed portion of each of the panels may be complimentary so as to form a visual display which may include a graphic display which is only apparent when the lottery ticket is in the folded condition. It will be noted that in the embodiment of FIG. 1, the panel 4 is larger than the panel 6 so that when the panel 6 is folded upon the panel 4, a portion of the panel 4 is visible beyond the physical limits of panel 6, and thus at least a portion of both panels are visible. It is this arrangement which enables the lottery ticket in the folded condition to form a three dimensional visual display which is different from the visual display formed by any other of the individual panels.

In one embodiment of the present invention, the panels 4, 6 are each comprised of respective upper portions 4a and 6a and respective lower portions 4b and 6b. In the embodiment shown in FIG. 1, the lower portions 4b and 6b are connected together through the common fold line 8 while the upper portions 4a and 6a are unattached to each other. It will be understood that the upper portions 4a and 6a may be attached to each other or both the upper and lower portions may be attached to each other so long as the panels may be folded upon each other in a complimentary manner to form a three dimensional visual display.

As shown in FIGS. 1 and 2, the lower portions 4b and 6b of the lottery ticket 2 are of the same size while the upper portions 4a and 6a are of different dimensions such that the upper portion 4a has a larger surface area than the upper portion 6a of the panel 6. The smaller panel 6 may be folded upon the larger panel 4 along the fold line 8 to assume the folded configuration shown in FIG. 2. When the lottery ticket 2 is in the folded condition shown in FIG. 2, a portion of the panel 4 extends above the panel 6 to provide a three-dimensional effect to the lottery ticket. The three-dimensional effect can be enhanced by providing graphics on the upper portion 4a of the panel 4 which lies above the upper portion 6a of the panel 6, and preferably to coordinate the graphics of the visible portions of the respective panels to provide a three-dimensional appearance when the lottery ticket is in the folded condition shown in FIG. 2. The combined graphics of the panels 4 and 6 as they appear in the folded condition shown in FIG. 2 can provide a unique visual display which cannot be achieved by single panel lottery tickets. In one embodiment of the invention, the graphics printed on the upper portion 4a blend or compliment the graphics present on the upper portion 6a to form a unique three dimensional visual display which is different than the visual display on any one panel.

Each of the panels 4 and 6 of the lottery ticket 2 shown in FIG. 1 have respective front faces 10a and 10b and corresponding rear faces 12a and 12b. One or both of the front faces 10a and 10b and one or both of the rear faces 12a and 12b of the lottery ticket 2 may contain a game area for playing a scratch-off lottery game. In the embodiment shown in FIG. 1, the lottery ticket 2 has a first game area 14 imprinted on the front face 10a of the panel 4 in the upper portion 4a thereof. A second game area 16 is shown positioned in the lower portion 6b of the panel 6. The game areas can appear as shown in FIG. 1 in either or both of the upper portions 4a, 6a of the panels 4, 6. It will be understood that the game areas present on the lottery ticket may cover both the upper and lower portion of a single panel. It will be further understood that any one or more of the game areas may contain a separate game or an interactive game as defined herein.

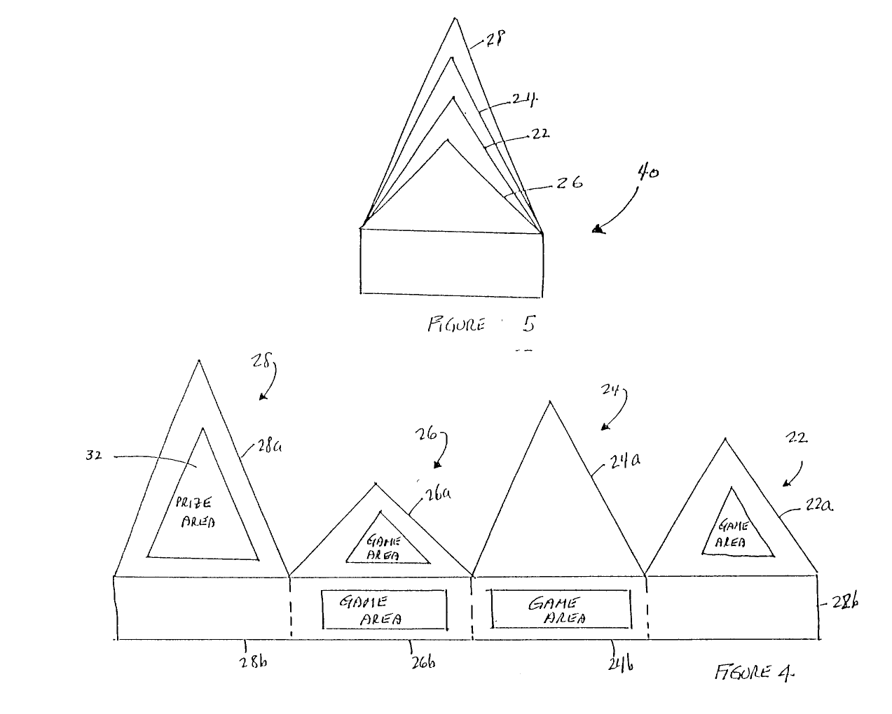

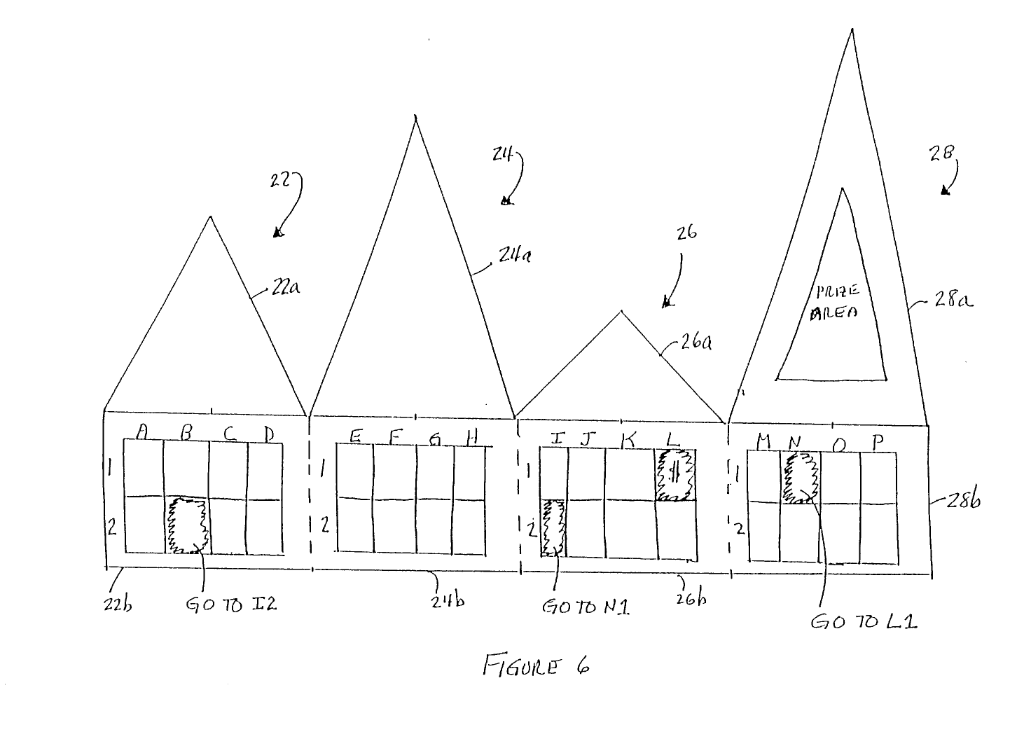

Another embodiment of the present invention is shown in FIG. 3 in which the lottery ticket 20 is comprised of four panels 22, 24, 26 and 28 each having respective upper portions 22a, 24a, 26a and 28a and lower portions 22b, 24b, 26b, 28b. Each pair of adjacent panels (e.g. panels 22 and 24) are separated from each other by a fold line 8 as previously described. The embodiment shown in FIG. 3 shows the rear face of each panel and includes a game area 30 as previously described containing a separate game or an interactive game on the lower portion thereof. More than one game area may be provided on the rear face of any one of the panels either in the upper portion (e.g. 22a) or the lower portion (e.g. 22b). In addition, one or more game areas may appear in both the upper and lower portion of a single panel. It will be noted that the size and/or shape of each of the panels 22, 24, 26 and 28 are different from each other so that when the respective panels are folded upon each other they assume the configuration shown in FIG. 5 as hereinafter described.

The front face of the lottery ticket described above in connection with FIG. 3 is shown specifically in FIG. 4. In this embodiment, the upper portion 22a of the panel 22 includes a game area shown generally by the numeral 30 while the lower portion 24b includes a separate game area 30. The panel 26 includes a game area in both the upper portion 26a and the lower portion 26b, while the panel 28 has a prize designation area 32 in the upper portion 28a of the panel 28. The prize designation area 32 is an optional feature of the lottery ticket and can provide information about prizes that may have been won by playing one or more of the games in the respective game areas described above.

When the panels 22, 24, 26, and 28 are folded upon each other, they may form a lottery ticket 40 in the folded condition as shown in FIG. 5. In particular, the lottery ticket 40 shows the four panels 22, 24, 26 and 28 superimposed over each other so that they are arranged in ascending order thereby providing a unique three-dimensional arrangement which when provided with suitable graphics can complete or generate a new visual display, which is particularly pleasing to the lottery player and which is typically not obtainable from a single panel ticket or a multiple panel ticket in which the panels are not foldable upon each other. In a preferred form of the invention, the entire front of the lottery ticket as shown in FIG. 5 is void of any disclosure of a game area so that the entire front face of the ticket in the folded condition shows only the printed graphics that create a particular visual display.

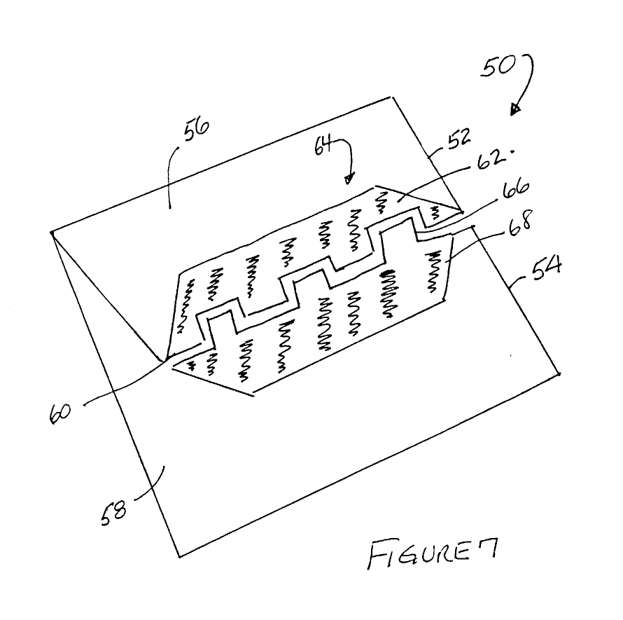

In a further embodiment of the invention, at least two of the game areas are employed to provide an interactive game. Referring to FIG. 6, the front face of the lottery ticket shown therein contains game areas in each of the lower portions 22b, 24b, 26b, 28b of the respective panels 22, 24, 26 and 28. The game areas in each of the panels are interactive because a single game is played across multiple panels. In particular, the lower portion of each panel contains a grid of letters and numbers as indicated. In the panel 22 the player uncovers (by removing the scratch-off layer) the play area B2 which instructs the player to go to panel 26 and uncover play are 12. When the scratch-off layer for 12 is removed, the directions instruct the player to go to play area N1 in panel 28. Eventually the player ends up at play area L1 in panel 26 where a symbol ($) is uncovered which may correspond to a prize in the prize designation area found in the upper portion 28a of panel 28.

In a still further embodiment of the invention, the lottery ticket is comprised of multiple panels folded upon or in proximity of each other from top to bottom rather than side to side as shown in the embodiments of FIGS. 1-6.

Referring to FIG. 7, a lottery ticket 50 includes an upper panel 52 and a lower panel 54 with respective front faces 56 and 58. The front face 56 is shown with an edge cut design 60 and a portion 62 of an overall graphic design 64. The front face 58 of the lower panel 54 has a complimentary edge unit design 66 and a complimentary graphic design portion 68 of the overall graphic design 64. When the top and bottom panels 52 and 54 are folded upon each other they visually display the overall design of the lottery ticket.

In the embodiment shown in FIG. 7, the panels are in proximity to each other to form a two dimensional visual display. If the panels are constructed to fold upon each other with an appropriate adjustment in the design elements of each panel, a three-dimensional visual display is produced.

Thus, multiple game areas on multiple panels may be employed to play an interactive game. It will be understood that a variety of interactive formats may be used to play an interactive game.

Lottery tickets of the present invention can be used to form visual displays including three-dimensional visual displays such as holiday scenes, Las Vegas Hotels, spaceships and numerous other designs which are highly attractive to the lottery player. The present tickets are also desirable because they contain multiple panels at least some of which can contain at least one, typically several lottery games to provide added amusement to the lottery player as well as the opportunity to win one or more prizes.

What is claimed is:

1. A lottery ticket comprising:
a plurality of panels each having a front face exhibiting an incomplete visual display thereon and a rear face and being foldable upon or in proximity to each other;
at least two of the faces being placed over or in proximity to each other and together forming a face of the lottery ticket having a complete visual display formed by the positioning of the incomplete visual display of the front faces of the panels; and
a game area appearing on at least one of the panels.

2. The lottery ticket of claim 1 wherein at least two of the front faces of the plurality of panels are placed over each other to form the face of the lottery ticket with the complete visual display.

3. The lottery ticket of claim 1 wherein at least two of the front faces of the plurality of panels are placed in proximity to each other to form the face of the lottery ticket with the complete visual display.

4. The lottery ticket of claim 2 wherein the complete visual display is three-dimensional.

5. The lottery ticket of claim 1 comprised of four panels with up to all of the front faces of the panels forming the front face of the lottery ticket.

6. The lottery ticket of claim 1 wherein the front face of at least one of the panels comprises a first game area.

7. The lottery ticket of claim 1 wherein each of the panels has a rear face, at least one of the rear faces comprises a second game area.

8. The lottery ticket of claim 1 comprising four panels including a top most panel, a bottom most panel and a pair of intermediate panels, said top most panel lying above the bottom most panel and the intermediate panels wherein the panels are folded upon each other.

9. The lottery ticket of claim 8 wherein the height of the top most panel is greater than at least one of the bottom most and intermediate panels.

10. The lottery ticket of claim 1 comprising at least one interactive game.

11. The lottery ticket of claim 10 comprising at least two game areas for playing an interactive game.
